(19) United States
(12) Patent Application Publication
(10) Pub. No.: US 2020/0185979 A1
(43) Pub. Date: Jun. 11, 2020

(54) DEVICE FOR TRANSFERRING AND RECEIVING WIRELESS POWER AND METHOD FOR ADJUSTING POWER THEREOF

(71) Applicant: SAMSUNG ELECTRONICS CO., LTD., Suwon-si (KR)

(72) Inventors: Kyungmin PARK, Suwon-si (KR); Kyoungwon KIM, Suwon-si (KR); Yusu KIM, Suwon-si (KR); Wooram LEE, Suwon-si (KR); Juhyang LEE, Suwon-si (KR); Byungyeol CHOI, Suwon-si (KR)

(21) Appl. No.: 16/705,357

(22) Filed: Dec. 6, 2019

(30) Foreign Application Priority Data
Dec. 7, 2018 (KR) 10-2018-0157333

(51) Int. Cl. H02J 50/90; H02J 50/10; H02J 50/80; H02J 7/02

(52) U.S. Cl. CPC H02J 50/90; H02J 7/02; H02J 50/80; H02J 50/10

(57) ABSTRACT

Disclosed is an electronic device. A wireless power transferring device includes a first interface comprising interface circuitry, a conversion circuit, a coil, and a control circuit. The control circuit is configured to control the device to communicate with the power supply device to identify maximum supply power of the power supply device and set maximum transfer power to the maximum supply power or less based on the power supply device being connected to the first interface, to generate the transfer power based on power supplied from the power supply device using the conversion circuit, to transfer the generated transfer power to a wireless power receiving device using the coil, to determine whether the request is for power adjustment exceeding the maximum transfer power based on receiving a request for power adjustment from the wireless power receiving device, to adjust the transfer power using the conversion circuit in response to the request based on the request not being for power adjustment exceeding the maximum transfer power, and to ignore the request to adjust the transfer power based on the request for power adjustment exceeding the maximum transfer power.

### CROSS-REFERENCE TO RELATED APPLICATION

This application is based on and claims priority under 35 U.S.C. § 119 to Korean Patent Application No. 10-2018-0157333, filed on Dec. 7, 2018, in the Korean Intellectual Property Office, the disclosure of which is incorporated by reference herein its entirety.

### BACKGROUND

### 1. Field

The disclosure relates to a technology for transferring wireless power.

### 2. Description of Related Art

A portable terminal such as a mobile phone or a notebook computer includes a battery for storing power and a circuit for charging the battery. Such the portable terminal needs to receive power from an external charger (e.g., a travel adapter (TA)). When a connector included in the portable terminal is connected to a plug of the external charger, the portable terminal may receive power from the external charger. In a wireless charging system, as the portable terminal approaches the wireless charger without being connected to the wireless charger, the portable terminal may receive power from the wireless charger. To this end, when the wireless charger receives power from an external power supply device, the wireless charger may convert the received power so as to correspond to the request of a portable terminal and then may transfer the received power.

However, when the portable terminal is incorrectly coupled to the wireless charger (misaligned state), the portable terminal may not properly receive power from the wireless charger. In this case, the portable terminal may request the wireless charger to increase power, and then the wireless charger may attempt to increase power in response to the request even though transmitting the maximum power capable of being supplied. Then, because the power transfer efficiency (reception power compared to transfer power) is low, the overload (e.g., overheating state) may occur in the wireless charger or the external power supply device.

As such, the conventional portable terminal has limited the upper limit of the requirement power such that the overload does not occur in a state where the conventional portable terminal is misaligned with the wireless charger.

The above information is presented as background information only to assist with an understanding of the disclosure. No determination has been made, and no assertion is made, as to whether any of the above might be applicable as prior art with regard to the disclosure.

### SUMMARY

Embodiments of the disclosure address at least the above-mentioned problems and/or disadvantages and provide at least the advantages described below. Accordingly, an example aspect of the disclosure is to provide a device for transferring and receiving wireless power that prevents and/or reduces the overload from occurring in a misaligned state by changing the upper limit of the requirement power depending on the alignment state between a wireless power transferring device and a wireless power receiving device and a power adjusting method thereof.

In accordance with an example aspect of the disclosure, a wireless power transferring device may include a first interface capable of being connected to an external power supply device, a conversion circuit configured to generate transfer power, a coil configured to transfer the transfer power wirelessly, and a control circuit. The control circuit may be configured to control the wireless power transferring device to communicate with the power supply device to identify maximum supply power of the power supply device and set maximum transfer power to the maximum supply power or less based on the power supply device being connected to the first interface, to generate the transfer power based on power supplied from the power supply device using the conversion circuit, to transfer the generated transfer power to a wireless power receiving device using the coil, to determine whether a request is associated with the power adjustment exceeding the maximum transfer power based on receiving a request for power adjustment from the wireless power receiving device, to adjust the transfer power using the conversion circuit in response to the request based on the request not being associated with the power adjustment exceeding the maximum transfer power, and to ignore the request to adjust the transfer power based on the request being associated with the power adjustment exceeding the maximum transfer power.

In accordance with another example aspect of the disclosure, a wireless power receiving device may include a coil configured to receive power from a wireless power transferring device, a conversion circuit configured to convert the received power, a sensing circuit configured to sense the received power, a battery capable of being charged using the converted power, and a processor. The processor may be configured control the wireless power receiving device to detect the received power using the sensing circuit, determine whether the received power corresponds to requirement power for charging the battery, to transmit a request for power adjustment to the wireless power transferring device using the coil based on the received power not being associated with the requirement power, to determine whether the received power corresponds to the requirement power after transmitting the request, and to adjust the requirement power after transmitting the request multiple times based on the received power not corresponding to the requirement power.

In accordance with another example aspect of the disclosure, a power adjusting method by a wireless power transferring device may include: communicating with the power supply device to identify maximum supply power of the power supply device based on an external power supply device being connected to the wireless power transferring device, setting maximum transfer power to the identified maximum supply power or less, generating first transfer power based on power supplied from the power supply device using a conversion circuit, transferring the first transfer power to a wireless power receiving device using a coil, determining whether a request is associated with power adjustment exceeding the maximum transfer power based on receiving a request associated with power adjustment from the wireless power receiving device, adjusting the first transfer power using the conversion circuit in response to the request based on the request for the power adjustment not exceeding the maximum transfer power, and ignoring the request to adjust the first transfer power using the conversion circuit based on the request for the power adjustment exceeding the maximum transfer power.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIGS. 1A and 1B are diagrams illustrating an example wireless power transferring system, according to an embodiment;

FIG. 2 is a block diagram illustrating an example wireless power transferring device, according to an embodiment;

FIG. 3 is a block diagram illustrating an example wireless power receiving device, according to an embodiment;

FIG. 4 is a flowchart illustrating an example power adjusting method by a wireless power transferring device, according to an embodiment;

FIG. 5 is a signal flow diagram illustrating an example power adjusting method by a power transferring system, according to an embodiment;

FIG. 6 is a flowchart illustrating an example wireless power adjusting method by a wireless power receiving device, according to an embodiment; and

FIG. 7 is a block diagram illustrating an example electronic device in a network environment according to various embodiments.

### DETAILED DESCRIPTION

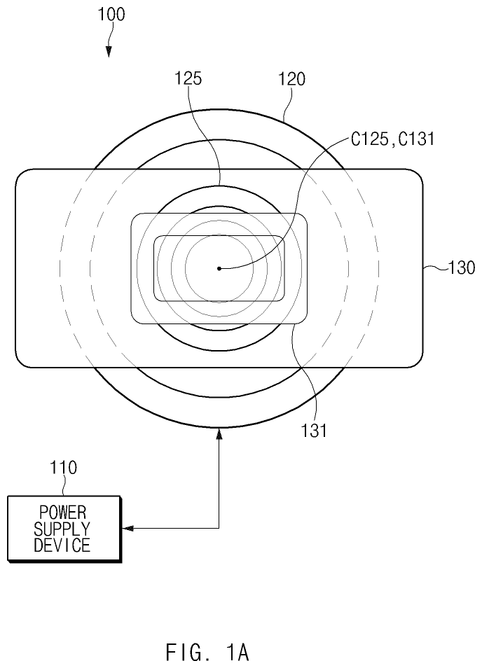

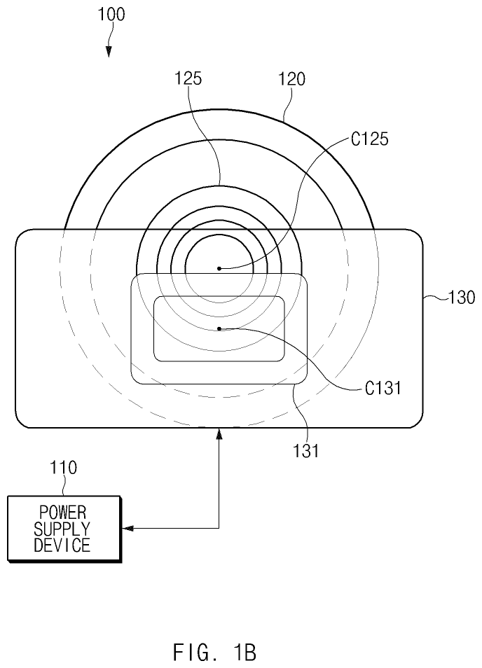

FIGS. 1A and 1B are diagrams illustrating an example wireless power transferring system, according to an embodiment.

Referring to FIGS. 1A and 1B, a wireless power transferring system 100 (a wireless charging system) according to an embodiment may include a power supply device 110, a wireless power transferring device 120, and a wireless power receiving device 130.

According to an embodiment, the power supply device 110 may receive alternating current (AC) power (e.g., the power between about 90 V and about 240 V) from an external power supply, may convert the received AC power into direct current (DC) power, and may output the converted power. For example, the converted power may be power of about 5 V or more and about 12 V or less. The power supply device 110 may be provided to supply (output) power of about 15 W (e.g., about 9 V/about 1.65 A). Furthermore, the power supply device 110 may be provided to perform the communication (e.g., communication in the manner of power delivery (PD) communication or auto frequency control (AFC)) with the wireless power transferring device 120. The power supply device 110 may transmit information associated with the supply power to the wireless power transferring device 120, in response to the request of the wireless power transferring device 120. According to various embodiments, the power supply device 110 may be included in the wireless power transferring device 120.

According to an embodiment, when the wireless power transferring device 120 is electrically connected to the power supply device 110, the wireless power transferring device 120 may communicate with the power supply device 110 and may identify information associated with maximum supply power of the power supply device 110. In this regard, when identifying (e.g., detecting) the specified signal (e.g., voltage) applied from the power supply device 110, the wireless power transferring device 120 may determine that the wireless power transferring device 120 is connected to the power supply device 110. When the wireless power transferring device 120 determines that the wireless power transferring device 120 is connected to the power supply device 110, for example, the wireless power transferring device 120 may make a request for the information associated with the maximum supply power to the power supply device 110 in the manner of AFC and may receive the information associated with the maximum supply power as the response to the request.

When identifying the information associated with the maximum supply power, the wireless power transferring device 120 may set maximum transfer power, which is not greater than the maximum supply power or less (e.g., less than or equal to the maximum power supply). For example, the wireless power transferring device 120 may set the maximum transfer power, based on the consumed power of the wireless power transferring device 120 at a point in time when the transfer power corresponding to the maximum transfer power is generated. For another example, the wireless power transferring device 120 may set the maximum transfer power such that the difference between the maximum supply power and the summed power of the consumed power and the maximum transfer power is not greater than the specified power magnitude. For example, the specified power magnitude may be set to the maximum power that prevents and/or reduces the damage to the component (e.g., a conversion circuit 123) of the wireless power transferring device 120 from occurring even though the maximum transfer power is continuously transferred during the specified time (e.g., 2 hours) or more.

According to an embodiment, when receiving a request for power transfer from the wireless power receiving device 130 approaching the wireless power transferring device 120 within the specified distance, the wireless power transferring device 120 may generate transfer power based on the power supplied from the power supply device 110 in response to the request and may then transmit the transfer power.

According to an embodiment, when receiving the power transferred from the wireless power transferring device 120, the wireless power receiving device 130 may determine whether the received power corresponds to the requirement power. When the received power does not correspond to the requirement power, the wireless power receiving device 130 may transmit a request for power adjustment. For example, the request for power adjustment may be to request the wireless power transferring device 120 to perform control to increase or decrease the transfer power.

According to an embodiment, when receiving the request for power adjustment, the wireless power transferring device 120 may determine whether the received request is associated with the adjustment of power exceeding the maximum transfer power. For example, prior to adjusting the transfer power depending on the request, the wireless power transferring device 120 may determine whether the transfer power adjusted depending on the request exceeds the maximum transfer power. When the received request is not associated with the adjustment of power exceeding the maximum transfer power, the wireless power transferring device 120 may adjust the transfer power in response to the request. On the other hand, when the received request is associated with the adjustment of power exceeding the maximum transfer power, the wireless power transferring device 120 may determine the power receiving device 130 to be in the misaligned state (refer to FIG. 1B) and may ignore the request and not adjust the transfer power.

According to an embodiment, the wireless power receiving device 130 may determine whether the received power corresponds to the requirement power after transmitting the request for the power adjustment. When the received power does not correspond to the requirement power, the wireless power receiving device 130 may transmit the request for power adjustment, specified multiple times (e.g., twice or more). After transmitting the request for power adjustment the number of times, the wireless power receiving device 130 may adjust the requirement power when the received power does not correspond to the requirement power.

According to various embodiments, for example, the power supply device 110 may include a travel adaptor (TA). The wireless power transferring device 120 may be a wireless charger and may be implemented as, for example, and without limitation, a pad type, a cradle type, an access point (AP) type, a small-sized base station type, a stand type, a ceiling buried type, a wall hanging type, or the like. The wireless power receiving device 130 may include, for example, and without limitation, a portable communication device (e.g., a smartphone), a computer device, a portable multimedia device, a mobile medical appliance, a camera, a wearable device, a home appliance, or the like.

According to various embodiments, each of the wireless power transferring device 120 and the wireless power receiving device 130 may include a coil 125 and a coil 131, respectively, and may transfer or receive power via the coil 125 and the coil 131. Due to the characteristics of the coil 125 and the coil 131, even though the wireless power transferring device 120 transfers the same power, the wireless power receiving device 130 may only receive relatively low power in a state (misaligned state) where the interval between the center C125 of the coil 125 and the center C131 of the coil 131 exceeds the specified interval as illustrated, for example, in FIG. 1B, as compared to a close state (center alignment state) by the interval between the center C125 of the coil 125 and the center C131 of the coil 131 less than the specified interval as illustrated, for example, in FIG. 1A.

According to the above embodiment, the wireless power transferring device 120 may transfer, to the wireless power receiving device 130, the maximum transfer power capable of being generated based on the power supplied from the power supply device 110. As ignoring a request for adjusting the power of the maximum transfer power or more, the wireless power transferring device 120 according to an embodiment may prevent and/or reduce the overload of the power supply device 110 or the wireless power transferring device 120 from occurring in the misaligned state of the wireless power receiving device 130.

According to an embodiment, when the wireless power receiving device 130 is in the misaligned state, the wireless power transferring device 120 may make a request for power adjustment. When the power received after the power adjustment is requested does not reach a specified value, the wireless power transferring device 120 may adjust the received power to be lowered.

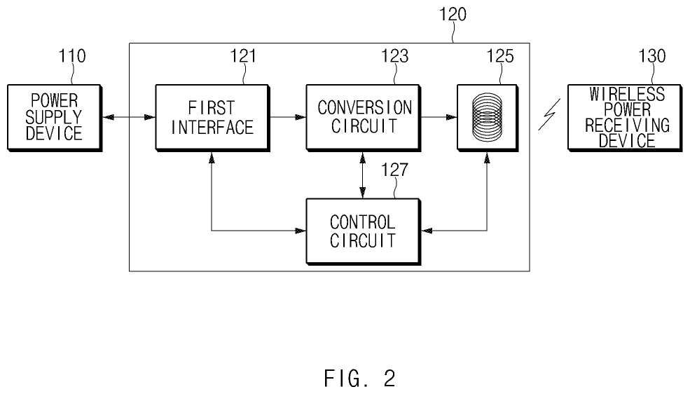

FIG. 2 is a block diagram illustrating an example wireless power transferring device, according to an embodiment.

Referring to FIG. 2, the wireless power transferring device 120 (e.g., the wireless power transferring device 120 of FIG. 1) according to an embodiment may include a first interface (e.g., including interface circuitry) 121, the conversion circuit 123, the coil 125 (e.g., the coil 125 of FIG. 1), and a control circuit 127. In an embodiment, the wireless power transferring device 120 may exclude some components or may further include other additional components. For example, the wireless power transferring device 120 may further include a matching circuit (not illustrated) for matching impedance with the coil 125. In an embodiment, some components of the wireless power transferring device 120 may be combined to form one entity, which may identically or similarly perform functions of the corresponding components before the combination.

According to an embodiment, when the first interface 121 is electrically connected to the power supply device 110, the first interface 121 may receive power from the power supply device 110. For example, the first interface 121 may include a socket to which the plug included in the power supply device 110 is fastened.

According to an embodiment, the conversion circuit 123 may generate transfer power, using the power supplied from the power supply device 110. For example, the conversion circuit 123 may include an inverter that converts DC into AC. For example, the conversion circuit 123 may generate AC power (transfer power) having the specified frequency, using the DC power supplied from the power supply device 110. For example, the specified frequency may be set depending on the power transferring scheme of the wireless power transferring device 120. For example, when the power transferring scheme of the wireless power transferring device 120 is a magnetic induction scheme, the specified frequency may, for example, include the frequency that is not less than about 110 kHz and is not greater than about 357 kHz. For another example, when the power transferring scheme of the wireless power transferring device 120 is a magnetic resonance scheme, the specified frequency may be about 6.78 MHz.

According to an embodiment, when the transfer power output from the conversion circuit 123 is supplied, the coil 125 may transfer the supplied transfer power wirelessly. For example, the coil 125 may transfer power in the magnetic induction scheme. The coil 125 may be provided in the form of, for example, and without limitation, a circle, oval, rectangle, rounded rectangle, or the like. According to various embodiments, the coil 125 may transfer the power in, for example, and without limitation, a magnetic resonance scheme, a microwave scheme, or the like.

For example, the control circuit 127 may include various processing circuitry, such as, for example, and without limitation, at least one of a central processing unit (CPU), a graphics processing unit (GPU), a microprocessor, an application processor (AP), an application specific integrated circuit (ASIC), a field programmable gate arrays (FPGA), or the like, and may include a plurality of cores.

According to an embodiment, when the power supply device 110 is connected to the first interface 121, the control circuit 127 may communicate with the power supply device 110 to identify the maximum supply power of the power supply device 110. In this regard, when the control circuit 127 identifies (e.g., detects) the specified signal (e.g., voltage) via the first interface 121, the control circuit 127 may identify that the power supply device 110 is connected to the first interface 121. When the control circuit 127 identifies the power supply device 110 connected to the first interface 121, the control circuit 127 may request the information associated with the maximum supply power from the power supply device 110 in, for example, the AFC scheme and may receive the information associated with the maximum supply power as the response to the request to identify the maximum supply power based on the information.

When the maximum supply power is identified, the control circuit 127 may set the maximum transfer power to the maximum supply power or less. For example, the control circuit 127 may set the maximum transfer power, based on the consumed power of the wireless power transferring device 120 at a point in time when the transfer power corresponding to the maximum transfer power is generated using the conversion circuit 123. For another example, the wireless power transferring device 120 may set the maximum transfer power such that the difference between the maximum supply power and the summed power of the consumed power and the maximum transfer power is not greater than the specified power magnitude (e.g., about 0.05 W). The control circuit 127 may store the information associated with maximum transfer power in a memory (e.g., a storage included in the control circuit).

In an embodiment, even though the control circuit 127 is electrically connected to the power supply device 110, when the control circuit 127 does not approach the wireless power receiving device 130 within a specified distance, the control circuit 127 may operate in a low-power mode. In the low-power mode, the control circuit 127 may be periodically activated (e.g., wake-up) to transfer specified low-power via the coil 125 and may monitor whether the response (e.g., a request for power transfer) to the low-power transferred from the wireless power receiving device 130 is received. When the response is not received from the wireless power receiving device 130, the control circuit 127 may be deactivated (e.g., sleep) until the next period is reached. The control circuit 127 may deactivate a component for transferring power in a sleep state and may drive only the component (e.g., a timer) capable of monitoring whether the next period has elapsed.

According to an embodiment, the control circuit 127 may receive a request for power transfer from the wireless power receiving device 130 via the coil 125. When receiving the request for power transfer, the control circuit 127 may generate transfer power based on the power supplied from the power supply device 110 via the conversion circuit 123 and may transmit the generated transfer power to the wireless power receiving device 130, using the coil 125. For example, the request for power transfer may include information associated with the requirement power. In this example, the control circuit 127 may generate and transfer the transfer power corresponding to the requirement power. When the requirement power exceeds maximum transfer power, the control circuit 127 may generate and transfer the transfer power corresponding to the maximum transfer power.

According to an embodiment, when receiving the request for power adjustment from the wireless power receiving device 130, the control circuit 127 may determine whether the received request is associated with the power adjustment exceeding the maximum transfer power. For example, when it is estimated or determined that the power adjusted in response to the received request exceeds the maximum transfer power, the control circuit 127 may determine that the received request is associated with the power adjustment exceeding the maximum transfer power. For another example, while the control circuit 127 transfers the transfer power corresponding to the maximum transfer power using the conversion circuit 123, when the control circuit 127 receives a request for increasing power, the control circuit 127 may determine that the received request is associated with the power adjustment exceeding the maximum transfer power.

According to an embodiment, when the received request is not associated with the power adjustment exceeding the maximum transfer power, the control circuit 127 may adjust the transfer power, using the conversion circuit 123. For example, when the received request is a request for increasing power, the control circuit 127 may increase the transfer power, using the conversion circuit 123. When the received request is a request for decreasing power, the control circuit 127 may decrease the transfer power, using the conversion circuit 123. In this regard, as the control circuit 127 may control the conversion circuit 123, the control circuit 127 may adjust (e.g., increase or decrease) the amount of current supplied to the coil 125 corresponding to the output power of the conversion circuit 123.

According to an embodiment, when the received request is associated with the power adjustment exceeding the maximum transfer power, the control circuit 127 may ignore the request and may not adjust the transfer power.

According to an embodiment, until the control circuit 127 receives a request for interrupting the power transfer from the wireless power receiving device 130 via the coil 125, the control circuit 127 may continue power transfer. When the control circuit 127 receives the request for interrupting the power transfer, the control circuit 127 may stop transferring the transfer power using the conversion circuit 123 and the coil 125 and may then operate in a low-power mode.

According to various embodiments, the wireless power transferring device 120 may bidirectionally communicate with the wireless power receiving device 130. In this example, when the request for the power adjustment is associated with the power adjustment exceeding the maximum transfer power, the wireless power transferring device 120 may transmit the response associated with the not providing the power adjustment to the wireless power receiving device 130.

According to the above embodiment, the wireless power transferring device 120 may transfer, to the wireless power receiving device 130, the maximum transfer power capable of being generated based on the power supplied from the power supply device 110. Furthermore, as ignoring a request for adjusting power of the maximum transfer power or more, the wireless power transferring device 120 according to an embodiment may prevent and/or reduce the overload of the power supply device 110 or the wireless power transferring device 120 from occurring in the misaligned state of the wireless power receiving device 130.

According to an example embodiment, a wireless power transferring device (e.g., the wireless power transferring device 120 of FIG. 2) may include a first interface (e.g., the first interface 121 of FIG. 2) comprising interface circuitry capable of being connected to an external power supply device (e.g., the power supply device 110 of FIG. 2), a conversion circuit (e.g., the conversion circuit 123 of FIG. 2) configured to generate transfer power, a coil (e.g., the coil 125 of FIG. 2) configured to transfer the transfer power wirelessly, and a control circuit (e.g., the control circuit 127 of FIG. 2). The control circuit may be configured to communicate with the power supply device to identify a maximum supply power of the power supply device and set a maximum transfer power to the maximum supply power or less based on the power supply device being connected to the first interface, to generate the transfer power based on power supplied from the power supply device using the conversion circuit, to transfer the generated transfer power to a wireless power receiving device using the coil, to determine whether the request is associated with the power adjustment exceeding the maximum transfer power based on receiving a request for power adjustment from the wireless power receiving device, to adjust the transfer power using the conversion circuit in response to the request based on the request not being associated with the power adjustment exceeding the maximum transfer power, and to ignore the request to adjust the transfer power based on the request being associated with the power adjustment exceeding the maximum transfer power.

The control circuit may be configured to set the maximum transfer power based on consumed power of the wireless power transferring device at a point in time at which the transfer power corresponding to the maximum transfer power is generated using the conversion circuit.

The control circuit may be configured to set the maximum transfer power such that summed power of the consumed power and the maximum transfer power has a difference of a specified power magnitude or less from the maximum supply power.

The control circuit may be configured to determine that the request is associated with the power adjustment exceeding the maximum transfer power based on it being estimated that power adjusted in response to the request exceeds the maximum transfer power.

The control circuit may be configured to adjust an amount of current supplied to the coil using the conversion circuit in response to the request.

The control circuit may be configured to receive a request associated with the power adjustment via the coil.

The control circuit may be configured to transmit a response associated with not providing the power adjustment to the wireless power receiving device based on the request being associated with the power adjustment exceeding the maximum transfer power.

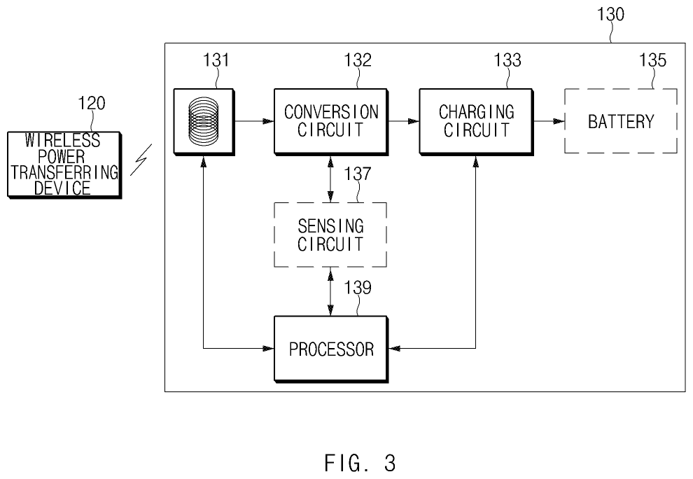

FIG. 3 is a block diagram illustrating an example wireless power receiving device, according to an embodiment.

Referring to FIG. 3, the wireless power receiving device 130 (e.g., the wireless power receiving device 130 of FIG. 1) according to an embodiment may include the coil 131 (e.g., the coil 131 of FIG. 1), a conversion circuit 132, a charging circuit 133, a battery 135, a sensing circuit 137, and a processor (e.g., including processing circuitry) 139. In an embodiment, the wireless power receiving device 130 may exclude some components or may further include other additional components. For example, the wireless power receiving device 130 may further include a matching circuit (not illustrated) for matching impedance with the coil 131. In an embodiment, some components of the wireless power receiving device 130 may be combined to form one entity, which may identically or similarly perform functions of the corresponding components before the combination.

According to an embodiment, the coil 131 may receive the power transferred from the wireless power transferring device 120 (e.g., the wireless power transferring device 120 of FIG. 1). For example, the second coil may receive the power transferred from the wireless power transferring device 120 in a magnetic induction scheme. The coil 131 may be provided in the form of, for example and without limitation, a circle, oval, rectangle, rounded rectangle, or the like. According to various embodiments, the coil 131 may receive the power transferred from the wireless power transferring device 120 in a magnetic resonance scheme.

According to an embodiment, the conversion circuit 132 may convert the power having a specified frequency received via the coil 131, into DC power. For example, the conversion circuit 132 may include a rectification circuit converting AC power into DC power.

According to an embodiment, the charging circuit 133 may charge the battery 135, using the output power of the conversion circuit 132. For example, the charging circuit 133 may be implemented using at least part of a power management integrate circuit (PMIC). For example, while charging the charging current of the battery 135 based on the voltage magnitude of the battery 135, the charging circuit 133 may charge the battery 135.

According to an embodiment, the battery 135 may be charged using the power (e.g., the voltage of about 4.2 V) received via the charging circuit 133. In a charging procedure, the constant current charging or constant voltage charging may be performed on the battery 135 depending on the voltage magnitude (or state of charge) of the battery 135.

According to an embodiment, the sensing circuit 137 may detect the power received via the coil 131. For example, the sensing circuit 137 may detect the output voltage of the conversion circuit 132 and then may output a signal corresponding to the detected voltage. According to various embodiments, the sensing circuit 137 may be included in the processor 139.

For example, the processor 139 may include various processing circuitry, such as, for example, and without limitation, at least one a central processing unit (CPU), a graphic processing unit (GPU), a microprocessor, an application processor (AP), an application specific integrated circuit (ASIC), a field programmable gate arrays (FPGA), or the like, and may have a plurality of cores.

According to an embodiment, when receiving a specified low-power using the coil 131, the processor 139 may determine that the wireless power transferring device 120 approaches the wireless power receiving device 130 within a specified distance and may set the requirement power for charging the battery 135, using the charging circuit 133. For example, in a state where the distance between the center of the coil 125 included in the wireless power transferring device 120 and the center of the coil 131 included in the wireless power receiving device 130 is less than a specified interval, the requirement power may be set to correspond to (e.g., to be the same as) power at a point in time when the wireless power transferring device 120 transfers the maximum transfer power.

According to an embodiment, the processor 139 may transmit the request for the power transfer to the wireless power transferring device 120 via the coil 131. For example, the request for the power transfer may include information (e.g., the power magnitude or the amount of current to be received) associated with the requirement power. In this regard, when receiving the request for power transfer, the wireless power transferring device 120 may transfer power in response to the request.

According to an embodiment, when receiving the power of a specified frequency via the coil 131, the processor 139 may convert the received power into DC power, using the conversion circuit 132. Afterward, the processor 139 may detect the output power of the conversion circuit 132, using the sensing circuit 137 and may determine whether the detected power corresponds to (e.g., is the same as) the requirement power. For example, when the mean value of the detected voltage is within a specified error range (e.g., about −0.1 V to +0.1 V) from the required voltage (corresponding to the requirement power), the processor 139 may determine that the output power corresponds to the requirement power.

According to an embodiment, when the output power of the conversion circuit 132 does not correspond to the requirement power, the processor 139 may transmit the request for power adjustment. For example, when the output power of the conversion circuit 132 is less than the requirement power, the processor 139 may transmit the request for the adjustment to increase in the transfer power. When the output power of the conversion circuit 132 is greater than the requirement power, the processor 139 may transmit the request for the adjustment to decrease in the transfer power.

According to an embodiment, after transferring the request for power adjustment, the processor 139 may determine whether the received power (e.g., the output power of the conversion circuit 132) corresponds to the requirement power. When the output power of the conversion circuit 132 does not correspond to the requirement power even after the processor 139 transmits the request for power adjustment, the processor 139 may transmit the request for power adjustment again. When the received power does not correspond to the requirement power even after the processor 139 transmits the request for power adjustment the number of times, the processor 139 may adjust the requirement power. For example, when the received power does not correspond to the requirement power even after the processor 139 transmits the request for the increase in power the number of times, the processor 139 may adjust the requirement power to be lowered. According to various embodiments, when the received power does not correspond to the requirement power even after the processor 139 transmits the request for the decrease in power the specified number of times, the processor 139 may make a request for interrupting the charging or may control the power supplied to a charging circuit or a battery to be lowered.

According to various embodiments, when bidirectionally communicating with the wireless power transferring device 120, the wireless power receiving device 130 may receive a response associated with not providing power adjustment from the wireless power transferring device 120, after transmitting a request for adjusting the increase in power to the wireless power transferring device 120. In this example, when receiving the response associated with not providing power adjustment, the wireless power receiving device 130 may determine that it is not able to receive higher power from the wireless power transferring device 120 and may then adjust the requirement power for charging the battery 135 to be lowered.

According to the above-described embodiment, because the wireless power receiving device 130 receives the power corresponding to the maximum transfer power capable of being supplied by the wireless power transferring device 120, the wireless power receiving device 130 may set the requirement power corresponding to the misaligned state and may receive the power corresponding to the set requirement power to charge the battery 135.

According to an embodiment, a wireless power receiving device (e.g., the wireless power receiving device 130 of FIG. 3) may include a coil (e.g., the coil 131 of FIG. 3) configured to receive power from a wireless power transferring device, a conversion circuit (e.g., the conversion circuit 132 of FIG. 3) configured to convert the received power, a sensing circuit (e.g., the sensing circuit 137 of FIG. 3) configured to sense the received power, a battery (e.g., the battery 135 of FIG. 3) capable of being charged using the converted power, and a processor (e.g., the processor 139 of FIG. 3). The processor may be configured to control the wireless power receiving device to detect the received power using the sensing circuit, to determine whether the received power corresponds to requirement power for charging the battery, to transmit a request for power adjustment to the wireless power transferring device using the coil based on the received power not being associated with the requirement power, to determine whether the received power corresponds to the requirement power based on transmitting the request, and to adjust the requirement power based on transmitting the request multiple times based on the received power not corresponding to the requirement power.

The processor may be configured to control the wireless power receiving device to transmit a request for adjustment of decrease in transfer power to the wireless power transferring device based on the received power exceeding the requirement power, and to transmit a request for adjustment of increase in the transfer power to the wireless power transferring device based on the received power being less than the requirement power.

The request may be a request for adjustment of increase in transfer power by the wireless power transferring device, and the processor may be configured to adjust the requirement power to be lowered based on transmitting the request multiple times, based on the received power not corresponding to the requirement power.

The processor may be configured to control the wireless power receiving device to restore the requirement power to a state before the requirement power is adjusted based on charging of the battery being completed.

The requirement power may correspond to power at a point in time at which the wireless power transferring device transfers transferable maximum transfer power where a center of a first coil included in the wireless power transferring device is within a specified distance of a center of a second coil included in the wireless power receiving device by less than a specified interval.

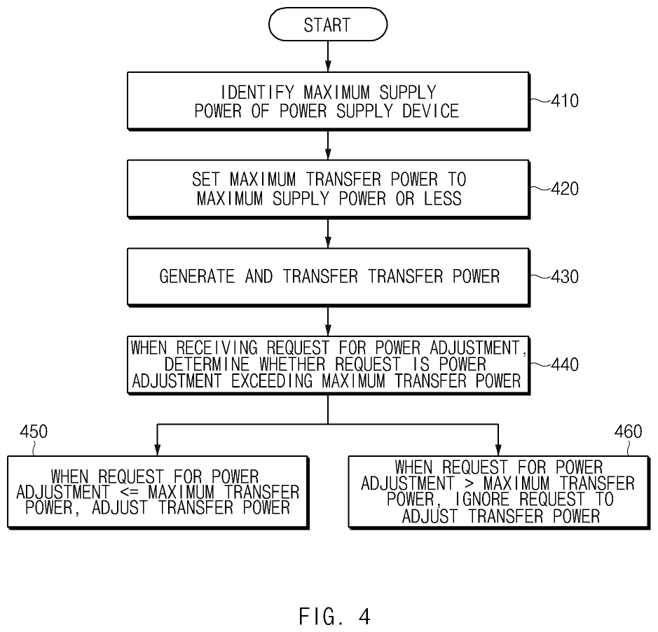

FIG. 4 is a flowchart illustrating an example power adjusting method by a wireless power transferring device, according to an embodiment.

Referring to FIG. 4, in operation 410, when the wireless power transferring device 120 (e.g., the wireless power transferring device 120 of FIG. 1) is electrically connected to the power supply device 110 (e.g., the power supply device 110 of FIG. 1), the wireless power transferring device 120 may communicate with the power supply device 110 to identify maximum supply power that the power supply device 110 is capable of supplying.

In operation 420, when the wireless power transferring device 120 identifies the maximum supply power, the wireless power transferring device 120 may set maximum transfer power to the maximum supply power or less. For example, the wireless power transferring device 120 may set the maximum transfer power, based on the consumed power of the wireless power transferring device 120 in the case where the transfer power corresponding to the maximum transfer power is generated. For another example, the wireless power transferring device 120 may set the maximum transfer power such that the difference between the maximum supply power and the summed power of the consumed power and the maximum transfer power of the wireless power transferring device 120 in the case where the transfer power corresponding to the maximum transfer power is generated is not greater than the specified power magnitude. For example, the specified power magnitude may be set to the maximum power that prevents and/or reduces the damage to the component (e.g., the conversion circuit 123) of the wireless power transferring device 120 from occurring even though the maximum transfer power is continuously generated and transferred during the specified time (e.g., 2 hours) or more.

In operation 430, the wireless power transferring device 120 may generate the transfer power based on the power supplied from the power supply device 110, using the conversion circuit 123 (e.g., the conversion circuit 123 of FIG. 2) and then may transfer the transfer power to the wireless power receiving device 130 (e.g., the wireless power receiving device 130 of FIG. 1), using the coil 125 (e.g., the coil 125 of FIG. 2). For example, the wireless power transferring device 120 may receive the request for power transfer from the wireless power receiving device 130 and may generate and transfer power in response to the request.

In operation 440, when receiving the request for power adjustment from the wireless power receiving device 130, the wireless power transferring device 120 may determine whether the received request is power adjustment exceeding the maximum transfer power. For example, before adjusting the power depending on the request, the wireless power transferring device 120 may mathematically estimate whether the transfer power adjusted depending on the request exceeds the maximum transfer power.

When the received request for power adjustment is for less than or equal to the maximum transfer power in operation 440, the wireless power transferring device 120 may adjust the transfer power in response to the received request, using the conversion circuit 123 in operation 450.

When the received request is power adjustment exceeds (e.g., is greater than) the maximum transfer power in operation 440, the wireless power transferring device 120 may ignore the received request to adjust the transfer power, using the conversion circuit 123 in operation 460.

According to the above-described embodiment, as the wireless power transferring device 120 transfers the maximum transfer power capable of being generated based on the power supplied from the power supply device 110 or less, to the wireless power receiving device 130 and ignores a request for adjusting the power of more than the maximum transfer, the wireless power transferring device 120 according to an embodiment may prevent and/or reduce the overload of the power supply device 110 or the wireless power transferring device 120 from occurring in the misaligned state of the wireless power receiving device 130.

According to an embodiment, a power adjusting method by a wireless power transferring device (e.g., the wireless power transferring device 120 of FIG. 2) may include communicating with the power supply device to identify a maximum supply power of the power supply device based on an external power supply device (e.g., the power supply device 110 of FIG. 2) being connected to the wireless power transferring device, setting a maximum transfer power to the identified maximum supply power or less, generating first transfer power based on power supplied from the power supply device using a conversion circuit (e.g., the conversion circuit 123 of FIG. 2), transferring the first transfer power to a wireless power receiving device using a coil (e.g., the coil 125 of FIG. 2), determining whether the request for power adjustment exceeds the maximum transfer power based on receiving a request for power adjustment from the wireless power receiving device (e.g., the wireless power receiving device 130 of FIG. 2), adjusting the first transfer power using the conversion circuit in response to the request based on the request for power adjustment not exceeding the maximum transfer power, and ignoring the request to adjust the first transfer power using the conversion circuit based on the request for power adjustment exceeding the maximum transfer power.

The setting may include setting the maximum transfer power based on consumed power of the wireless power transferring device at a point in time at which transfer power corresponding to the maximum transfer power is generated using the conversion circuit.

The setting of the maximum transfer power of the identified maximum supply power or less may further include setting the maximum transfer power such that summed power of the consumed power and the maximum transfer power has a difference of a specified power magnitude or less from the maximum supply power.

The determining of whether the request is associated with the power adjustment may include determining that the request is for power adjustment exceeding the maximum transfer power based on it being estimated that power adjusted in response to the request exceeds the maximum transfer power.

The adjusting of the first transfer power may include adjusting an amount of current supplied to the coil using the conversion circuit.

The power adjusting method may further include receiving a request for the power adjustment via the coil.

The power adjusting method may further include transmitting a response associated with not providing the power adjustment to the wireless power receiving device based on the request being associated with the power adjustment exceeding the maximum transfer power.

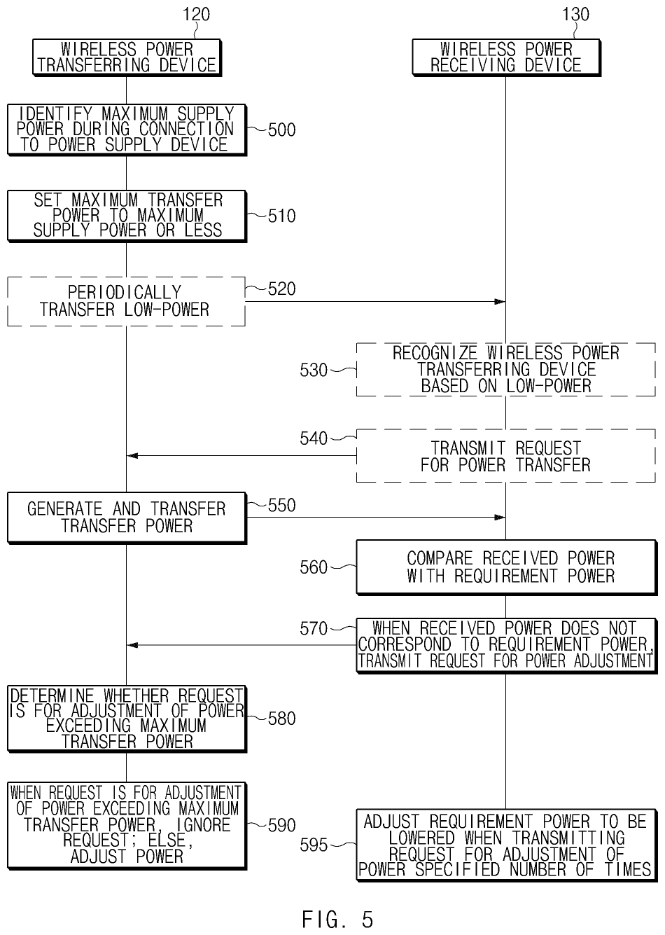

FIG. 5 is a signal flow diagram illustrating an example power adjusting method by a power transferring system, according to an embodiment.

Referring to FIG. 5, in operation 500, when the power supply device 110 (e.g., the power supply device 110 of FIG. 1) is connected to the wireless power transferring device 120, the wireless power transferring device 120 (e.g., the wireless power transferring device 120 of FIG. 1) may communicate with the power supply device 110 to identify maximum supply power that the power supply device 110 is capable of supplying.

In operation 510, the wireless power transferring device 120 may set maximum transfer power to the identified maximum supply power or less. For example, the wireless power transferring device 120 may set the maximum transfer power, based on the consumed power of the wireless power transferring device 120 at a point in time when the wireless power transferring device 120 generates the transfer power corresponding to the maximum transfer power. For another example, the wireless power transferring device 120 may set the maximum transfer power such that the difference between the maximum supply power and the summed power of the consumed power and the maximum transfer power of the wireless power transferring device 120 at a point in time at which the wireless power transferring device 120 generates the transfer power corresponding to the maximum transfer power is not greater than the specified power magnitude. For example, the specified power magnitude may be set to the maximum power that prevents and/or reduces the damage to the component (e.g., the conversion circuit 123) of the wireless power transferring device 120 from occurring even though the maximum transfer power is continuously generated and transferred during the specified time (e.g., 2 hours) or more.

In operation 520, the wireless power transferring device 120 may periodically transfer a specified low-power. For example, the wireless power transferring device 120 may be periodically activated (e.g., wake-up) to transfer specified low-power and may monitor whether the response (e.g., a request for power transfer) corresponding to the low-power transferred from the wireless power receiving device 130 is received. When the response is not received, the wireless power transferring device 120 may be deactivated (e.g., sleep) until the next period is reached.

In operation 530, when receiving the specified low-power, the wireless power receiving device 130 may recognize that the wireless power transferring device 120 approaches the wireless power receiving device 130 within a specified distance. When recognizing that the wireless power transferring device 120 approaches the wireless power receiving device 130 within the specified distance, the wireless power receiving device 130 may set the requirement power for charging the battery 135.

In operation 540, the wireless power receiving device 130 may transmit the request for power transfer to the wireless power transferring device 120. For example, the request for power transfer may include information associated with the requirement power. After operation 530 and before operation 540, an operation in which the wireless power receiving device 130 transmits unique identification information of the wireless power receiving device 130 and the wireless power transferring device 120 determines whether the wireless power receiving device 130 is the registered device based on the unique identification information may be included further.

In operation 550, upon receiving the request for power transfer, the wireless power transferring device 120 may generate the transfer power in response to the request for power transfer and then may transfer the generated transfer power. The wireless power transferring device 120 may identify the requirement power at the request for power transfer and then may generate and transfer the transfer power corresponding to the requirement power.

In operation 560, the wireless power receiving device 130 may compare the power received from the wireless power transferring device 120 with the requirement power. For example, the wireless power receiving device 130 may determine whether the magnitude of the received voltage corresponds to the magnitude of the requirement voltage.

In operation 570, when the received power does not correspond to the requirement power, the wireless power receiving device 130 may transmit the request for the power adjustment. For example, when the received power exceeds the requirement power, the wireless power receiving device 130 may transmit the request for the decrease in power. Furthermore, when the received power is less than the requirement power, the wireless power receiving device 130 may transmit the request for the increase in power.

In operation 580, when receiving the request for power adjustment, the wireless power transferring device 120 may determine whether the received request is for adjustment of power exceeding the maximum transfer power. For example, the wireless power transferring device 120 may determine or estimate whether the power adjusted depending on the request is the power exceeding the maximum transfer power.

In operation 590, when the received request is not adjustment of power exceeding the maximum transfer power (or when the received request is associated with the power adjustment of the maximum transfer power or less), the wireless power transferring device 120 may adjust the transfer power in response to the request. On the other hand, when the received request is adjustment of power exceeding the maximum transfer power, the wireless power transferring device 120 may determine that the wireless power receiving device 130 is in the misaligned state and may ignore the request to adjust the power.

In operation 595, when the received power does not correspond to the requirement power even after the wireless power receiving device 130 transmits the request for the increase in power the number of times, the wireless power receiving device 130 may adjust the requirement power to be lowered.

According to the above-described embodiment, as the wireless power transferring device 120 transfers the maximum transfer power capable of being generated based on the power supplied from the power supply device 110, to the wireless power receiving device 130 and ignores a request for adjusting the power of the maximum transfer power or more, the wireless power transferring device 120 according to an embodiment may prevent and/or reduce the overload of the power supply device 110 or the wireless power transferring device 120 from occurring due to the conventional misaligned state.

Also, according to the above-described embodiment, because the wireless power receiving device 130 receives the power corresponding to the maximum transfer power that the wireless power transferring device 120 is capable of supplying, the wireless power receiving device 130 may charge the battery 135 faster, as compared with the case where the requirement power corresponding to the conventional misaligned state is set and then the power corresponding to the set requirement power is received.

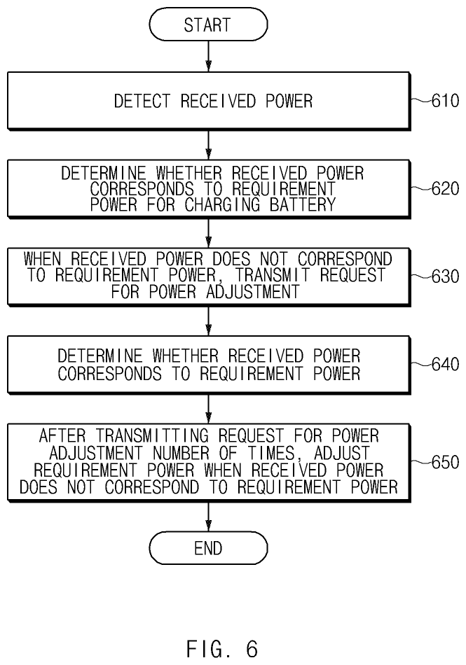

FIG. 6 is a flowchart illustrating an example wireless power adjusting method by a wireless power receiving device, according to an embodiment.

In operation 610, the wireless power receiving device 130 (e.g., the wireless power receiving device 130 of FIG. 3) may detect the received power, using a sensing circuit (the sensing circuit 137 of FIG. 3). For example, the wireless power receiving device 130 may detect the power, which is received using a coil (e.g., the coil 131 of FIG. 3) and then is converted and output using a conversion circuit (e.g., the conversion circuit 132 of FIG. 3), using a sensing circuit.

In operation 620, the wireless power receiving device 130 may determine whether the received power corresponds to the requirement power for charging a battery (e.g., the battery 135 of FIG. 3). For example, when the mean value of the detected voltage is within a specified error range (e.g., about −0.1 V to +0.1 V) from the required voltage (corresponding to the requirement power), the wireless power receiving device 130 may determine that the received power corresponds to the requirement power.

In operation 630, when the received power does not correspond to the requirement power, the wireless power receiving device 130 may transmit the request for the power adjustment to a wireless power transferring device (e.g., the wireless power transferring device 120 of FIG. 3), using a coil (e.g., the coil 131 of FIG. 3). For example, when the output power of the conversion circuit 132 is less than the requirement power, the wireless power receiving device 130 may transmit the request for the adjustment of the increase in the transfer power. Also, when the output power of the conversion circuit 132 is greater than the requirement power, the wireless power receiving device 130 may transmit the request for the adjustment of the decrease in the transfer power.

In operation 640, after transmitting a request for power adjustment, the wireless power receiving device 130 may determine whether the received power corresponds to the requirement power. When the output power of the conversion circuit 132 does not correspond to the requirement power even after the wireless power receiving device 130 transmits the request for power adjustment, the wireless power receiving device 130 may transmit the request for power adjustment again.

In operation 650, after transmitting the request for power adjustment the number of times, the wireless power receiving device 130 may adjust the requirement power when the received power does not correspond to the requirement power. For example, when the received power does not correspond to the requirement power even after the wireless power receiving device 130 transmits the request for the increase in power the number of times, the wireless power receiving device 130 may adjust the requirement power to be lowered.

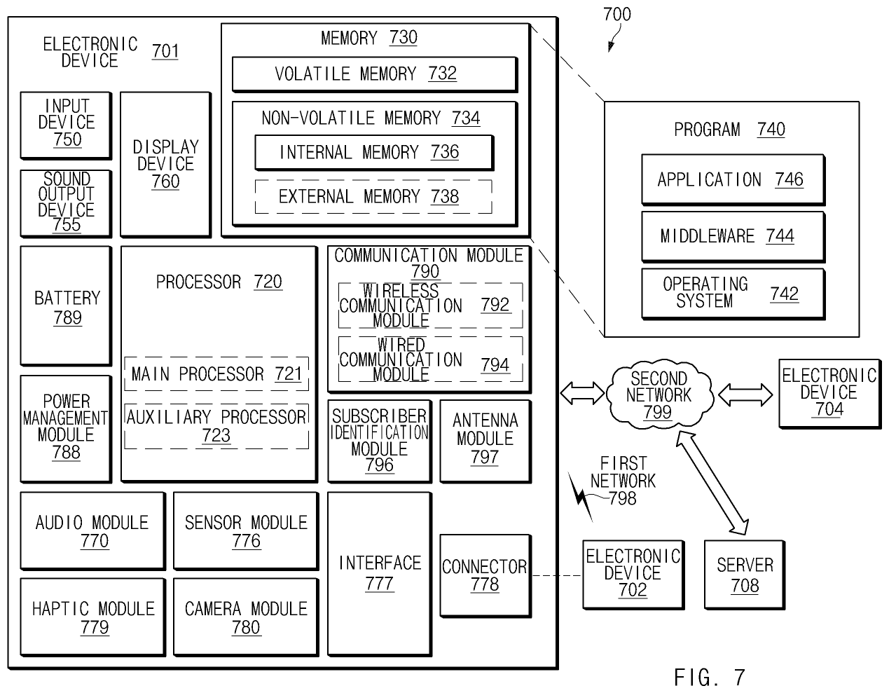

FIG. 7 is a block diagram illustrating an electronic device 701 in a network environment 700 according to various embodiments. Referring to FIG. 7, the electronic device 701 in the network environment 700 may communicate with an electronic device 702 via a first network 798 (e.g., a short-range wireless communication network), or an electronic device 704 or a server 708 via a second network 799 (e.g., a long-range wireless communication network). According to an embodiment, the electronic device 701 may communicate with the electronic device 704 via the server 708. According to an embodiment, the electronic device 701 may include a processor 720, memory 730, an input device 750, a sound output device 755, a display device 760, an audio module 770, a sensor module 776, an interface 777, a haptic module 779, a camera module 780, a power management module 788, a battery 789, a communication module 790, a subscriber identification module (SIM) 796, or an antenna module 797. In some embodiments, at least one (e.g., the display device 760 or the camera module 780) of the components may be omitted from the electronic device 701, or one or more other components may be added in the electronic device 701. In some embodiments, some of the components may be implemented as single integrated circuitry. For example, the sensor module 776 (e.g., a fingerprint sensor, an iris sensor, or an illuminance sensor) may be implemented as embedded in the display device 760 (e.g., a display).

The processor 720 may execute, for example, software (e.g., a program 740) to control at least one other component (e.g., a hardware or software component) of the electronic device 701 coupled with the processor 720, and may perform various data processing or computation. According to an example embodiment, as at least part of the data processing or computation, the processor 720 may load a command or data received from another component (e.g., the sensor module 776 or the communication module 790) in volatile memory 732, process the command or the data stored in the volatile memory 732, and store resulting data in non-volatile memory 734. According to an embodiment, the processor 720 may include a main processor 721 (e.g., a central processing unit (CPU) or an application processor (AP)), and an auxiliary processor 723 (e.g., a graphics processing unit (GPU), an image signal processor (ISP), a sensor hub processor, or a communication processor (CP)) that is operable independently from, or in conjunction with, the main processor 721. Additionally or alternatively, the auxiliary processor 723 may be adapted to consume less power than the main processor 721, or to be specific to a specified function. The auxiliary processor 723 may be implemented as separate from, or as part of the main processor 721.

The auxiliary processor 723 may control at least some of functions or states related to at least one component (e.g., the display device 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). According to an embodiment, the auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734.

The program 740 may be stored in the memory 730 as software, and may include, for example, an operating system (OS) 742, middleware 744, or an application 746.

The input device 750 may receive a command or data to be used by other component (e.g., the processor 720) of the electronic device 701, from the outside (e.g., a user) of the electronic device 701. The input device 750 may include, for example, a microphone, a mouse, a keyboard, or a digital pen (e.g., a stylus pen).

The sound output device 755 may output sound signals to the outside of the electronic device 701. The sound output device 755 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 760 may visually provide information to the outside (e.g., a user) of the electronic device 701. The display device 760 may include, for example, a display, a hologram device, or a projector and control circuitry to control a corresponding one of the display, hologram device, and projector. According to an embodiment, the display device 760 may include touch circuitry adapted to detect a touch, or sensor circuitry (e.g., a pressure sensor) adapted to measure the intensity of force incurred by the touch.

The audio module 770 may convert a sound into an electrical signal and vice versa. According to an embodiment, the audio module 770 may obtain the sound via the input device 750, or output the sound via the sound output device 755 or a headphone of an external electronic device (e.g., an electronic device 702) directly (e.g., wiredly) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. According to an embodiment, the sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device (e.g., the electronic device 702) directly (e.g., wiredly) or wirelessly. According to an embodiment, the interface 777 may include, for example, a high definition multimedia interface (HDMI), a universal serial bus (USB) interface, a secure digital (SD) card interface, or an audio interface.

A connecting terminal 778 may include a connector via which the electronic device 701 may be physically connected with the external electronic device (e.g., the electronic device 702). According to an embodiment, the connecting terminal 778 may include, for example, a HDMI connector, a USB connector, a SD card connector, or an audio connector (e.g., a headphone connector).

The haptic module 779 may convert an electrical signal into a mechanical stimulus (e.g., a vibration or a movement) or electrical stimulus which may be recognized by a user via his tactile sensation or kinesthetic sensation. According to an embodiment, the haptic module 779 may include, for example, a motor, a piezoelectric element, or an electric stimulator.

The camera module 780 may capture a still image or moving images. According to an embodiment, the camera module 780 may include one or more lenses, image sensors, image signal processors, or flashes.

The power management module 788 may manage power supplied to the electronic device 701. According to one embodiment, the power management module 788 may be implemented as at least part of, for example, a power management integrated circuit (PMIC).

The battery 789 may supply power to at least one component of the electronic device 701. According to an embodiment, the battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the application processor (AP)) and supports a direct (e.g., wired) communication or a wireless communication. According to an embodiment, the communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as Bluetooth™ wireless-fidelity (Wi-Fi) direct, or infrared data association (IrDA)) or the second network 799 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The antenna module 797 may transmit or receive a signal or power to or from the outside (e.g., the external electronic device) of the electronic device 701. According to an embodiment, the antenna module 797 may include an antenna including a radiating element composed of a conductive material or a conductive pattern formed in or on a substrate (e.g., PCB). According to an embodiment, the antenna module 797 may include a plurality of antennas. In such a case, at least one antenna appropriate for a communication scheme used in the communication network, such as the first network 798 or the second network 799, may be selected, for example, by the communication module 790 (e.g., the wireless communication module 792) from the plurality of antennas. The signal or the power may then be transmitted or received between the communication module 790 and the external electronic device via the selected at least one antenna. According to an embodiment, another component (e.g., a radio frequency integrated circuit (RFIC)) other than the radiating element may be additionally formed as part of the antenna module 797.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 701 and the external electronic device 704 via the server 708 coupled with the second network 799. Each of the electronic devices 702 and 704 may be a device of a same type as, or a different type, from the electronic device 701. According to an embodiment, all or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 701. The electronic device 701 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 740) including one or more instructions that are stored in a storage medium (e.g., internal memory 736 or external memory 738) that is readable by a machine (e.g., the electronic device 701). For example, a processor(e.g., the processor 720) of the machine (e.g., the electronic device 701) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to various example embodiments disclosed herein, the conventional overload occurring in the misaligned state of a wireless power receiving device may be prevented and/or reduced as the upper limit of the power required depending on the alignment state between a wireless power transferring device and a wireless power receiving device is changed. A variety of effects directly or indirectly understood through the disclosure may be provided.

While the disclosure has been illustrated and described with reference to various example embodiments thereof, it will be understood by those skilled in the art that various changes in form and details may be made therein without departing from the spirit and scope of the disclosure as set forth, for example, in the appended claims and their equivalents.

What is claimed is:

1. A wireless power transferring device, comprising:
a first interface comprising interface circuitry capable of being connected to an external power supply device;
a conversion circuit configured to generate transfer power;
a coil configured to transfer the transfer power wirelessly; and
a control circuit, wherein the control circuit is configured to control the wireless transferring device to:
communicate with the power supply device to identify a maximum supply power of the power supply device and set maximum transfer power to the maximum supply power or less based on the power supply device being connected to the first interface;
generate the transfer power based on power supplied from the power supply device using the conversion circuit;
transfer the generated transfer power to a wireless power receiving device using the coil;
determine whether a request for power adjustment is for power adjustment exceeding the maximum transfer power based on receiving the request for power adjustment from the wireless power receiving device;
adjust the transfer power using the conversion circuit in response to the request based on the request for the power adjustment not exceeding the maximum transfer power; and
ignore the request to adjust the transfer power based on the request for power adjustment exceeding the maximum transfer power.

2. The wireless power transferring device of claim 1, wherein the control circuit is configured to control the wireless power transferring device to:
set the maximum transfer power based on consumed power of the wireless power transferring device at a point in time at which the transfer power corresponding to the maximum transfer power is generated using the conversion circuit.

3. The wireless power transferring device of claim 2, wherein the control circuit is configured to control the wireless power transferring device to:
set the maximum transfer power such that a summed power of the consumed power and the maximum transfer power has a difference of a specified power magnitude or less from the maximum supply power.

4. The wireless power transferring device of claim 1, wherein the control circuit is configured to control the wireless power transferring device to:
determine that the request for the power adjustment exceeds the maximum transfer power based on estimating that power adjusted in response to the request exceeds the maximum transfer power.

5. The wireless power transferring device of claim 1, wherein the control circuit is configured to control the wireless power transferring device to:
adjust an amount of current supplied to the coil using the conversion circuit in response to the request.

6. The wireless power transferring device of claim 1, wherein the control circuit is configured to control the wireless power transferring device to:
receive a request associated with the power adjustment via the coil.

7. The wireless power transferring device of claim 1, wherein the control circuit is configured to control the wireless power transferring device to:
transmit a response associated with not providing the power adjustment to the wireless power receiving device based on the request for the power adjustment exceeding the maximum transfer power.

8. A wireless power receiving device, comprising:
a coil configured to receive power from a wireless power transferring device;
a conversion circuit configured to convert the received power;
a sensing circuit configured to sense the received power;
a battery capable of being charged using the converted power; and
a processor,
wherein the processor is configured to control the wireless power receiving device to:
detect the received power using the sensing circuit;
determine whether the received power corresponds to a requirement power for charging the battery;
transmit a request for power adjustment to the wireless power transferring device using the coil based on the received power not being associated with the requirement power;
determine whether the received power corresponds to the requirement power, based on transmitting the request; and
based on transmitting the request multiple times, adjust the requirement power based on the received power not corresponding to the requirement power.

9. The wireless power receiving device of claim 8, wherein the processor is configured to control the wireless power receiving device to:
transmit a request for adjustment to decrease transfer power to the wireless power transferring device based the received power exceeding the requirement power; and
transmit a request for adjustment to increase the transfer power to the wireless power transferring device based on the received power being less than the requirement power.

10. The wireless power receiving device of claim 8, wherein the request includes a request for adjustment to increase the transfer power by the wireless power transferring device, and
wherein the processor is configured to control the wireless power receiving device to:
based on transmitting the request multiple times, adjust the requirement power to be lowered based on the received power not corresponding to the requirement power.

11. The wireless power receiving device of claim 8, wherein the processor is configured to control the wireless power receiving device to:
restore the requirement power to a state before the requirement power is adjusted based on charging of the battery being completed.

12. The wireless power receiving device of claim 8, wherein the requirement power corresponds to power at a point in time at which the wireless power transferring device transfers transferable maximum transfer power, where a center of a first coil included in the wireless power transferring device approaches within a specified distance of a center of a second coil included in the wireless power receiving device by less than a specified interval.

13. A power adjusting method by a wireless power transferring device, the method comprising:
communicating with a power supply device to identify maximum supply power of the power supply device based on an external power supply device being connected to the wireless power transferring device;
setting maximum transfer power to the identified maximum supply power or less;
generating first transfer power based on power supplied from the power supply device using a conversion circuit;
transferring the first transfer power to a wireless power receiving device using a coil;
determining whether a request is associated with a power adjustment exceeding the maximum transfer power based on receiving the request associated with power adjustment from the wireless power receiving device;
adjusting the first transfer power using the conversion circuit in response to the request based on the request for power adjustment not exceeding the maximum transfer power; and
ignoring the request to adjust the first transfer power using the conversion circuit based on the request for power adjustment exceeding the maximum transfer power.

14. The method of claim 13, wherein the setting includes:
setting the maximum transfer power based on consumed power of the wireless power transferring device at a point in time at which transfer power corresponding to the maximum transfer power is generated using the conversion circuit.

15. The method of claim 14, wherein the setting of the maximum transfer power to the identified maximum supply power or less further includes:
setting the maximum transfer power such that summed power of the consumed power and the maximum transfer power has a difference of a specified power magnitude or less from the maximum supply power.

16. The method of claim 13, wherein the determining of whether the request is associated with the power adjustment includes:
determining that the request is for power adjustment exceeding the maximum transfer power based on estimating that power adjusted in response to the request exceeds the maximum transfer power.

17. The method of claim 13, wherein the adjusting of the first transfer power includes:
adjusting an amount of current supplied to the coil, using the conversion circuit.

18. The method of claim 13, further comprising:
receiving a request for the power adjustment via the coil.

19. The method of claim 13, further comprising:
transmitting a response associated with not providing the power adjustment to the wireless power receiving device based on the request for power adjustment exceeding the maximum transfer power.
